(19) United States
(12) Patent Application Publication
(10) Pub. No.: US 2011/0318094 A1
(43) Pub. Date: Dec. 29, 2011

(54) STRUT FOR CONNECTING FRAMES

(76) Inventor: Vincent Hensley, Gate City, VA (US)

(21) Appl. No.: 12/825,861

(22) Filed: Jun. 29, 2010

(51) Int. Cl. F16B 2/22; F16B 2/20

(52) U.S. Cl. 403/217; 403/291; 403/300

(57) ABSTRACT

A strut includes at least one bridge that provides a defined spacing between first and second frames in a longitudinal direction. At least a first connection portion is disposed on or near an end of the bridge and is resiliently elastically deformable at least in the longitudinal direction. The first connection portion may be press-fit between a base of the first frame and an engaging portion disposed on a flange that extends substantially perpendicular from the frame base. The first connection portion may comprise a base connected to the bridge with at least one inner clip projection having a first connecting member, and an outer clip comprising a base for abutting against a surface of the first frame and at least one outer clip projection extending from the outer clip base. The outer clip projection has a second connecting member that engages the first connecting member.

### TECHNICAL FIELD

The present invention relates to struts or insulating strips that support, connect and/or maintain the separation/spacing of two frames or profiles. In preferred embodiments, the struts may be utilized, e.g., in composite profiles for a window, a door or a facade element.

### BACKGROUND ART

A standard profiled construction element, such as a window, a door or facade element, comprises inner and outer metallic, normally aluminum, profiles or frames that extend parallel to each other and that are bridged by one or more struts or insulating strips, often formed of plastic. The outer metal profile is exposed to the elements on the outside of a building and the inside profile faces the interior, wherein the struts form a thermally-insulated bridge between the metal frames.

For example, DE 32 48 077 A1 discloses a composite profile comprising two aluminum frames, each having a pair of parallel metal flanges. At least one lip or projection extends perpendicular from the terminal end of at least one flange. A hollow plastic connection profile separates the two frames in the assembled state and has at least one undercut or groove on one side for engaging the respective lip on the metal flange. The composite profile is connected with one frame by engaging an undercut of the plastic profile with a metal lip and then pivoting the end of the plastic profile into a space between the parallel metal flanges, thereby securing the plastic profile to the two frames. At least one corner on an opposite side of the hollow plastic profile may have a beveled edge to facilitate the pivoting of the opposite side of the plastic profile into the space between the parallel metal flanges of the second frame. Two smaller ribs may be disposed on the metal frame between the metal flanges and may serve to support the terminal end of the plastic profile and to provide receptacles for receiving an adhesive that affixes the plastic profile to the metal frame.

U.S. Pat. No. 5,379,518 discloses a window sash having a connection member secured to first and second frames via double barbed connections.

In other known spacer profiles, the ends of the spacer profile are secured to the metal frames by plastically deforming at least one metal flange extending from the metal frame by a crimping, knurling or rolling-in process.

### SUMMARY

It is an object of the invention to provide improved struts or insulating strips for connecting two frames or profiles.

In one aspect of the present teachings, a strut is provided that is easy to install while still providing a reliable, sturdy connection between the two frames. For example, in such embodiments, a connection portion disposed on, at or near at least one terminal end of the strut may be press-fit into a receptacle defined on an inward-facing surface of a frame or profile.

Such an embodiment provides the advantage that the strut is relatively simple to produce and a composite structure comprising first and second frames spaced and supported by such a strut is relatively easy to assemble. For example, the strut can be press-fit into a corresponding recess structure defined on a frame by compressing a connection portion in the longitudinal direction. Thereafter, a restoring force securely maintains the connecting portion on the frame, e.g., in the recess structure.

In another aspect of the present teachings, a strut may include at least one bridge that provides a defined spacing between first and second frames in a longitudinal direction. At least a first connection portion may be disposed on, at or near an end of the bridge and is preferably resiliently elastically deformable at least in the longitudinal direction. The first connection portion may be press-fit between a base of the first frame and an engaging portion disposed on a flange that extends, e.g., substantially perpendicular from the frame base. The first connection portion may comprise a base connected to the bridge. The base may have at least one inner clip projection with a first connecting member defined thereon. An outer clip may comprise a base configured to abut against a surface of the first frame and at least one outer clip projection extending from the outer clip base. The outer clip projection has a second connecting member that engages the first connecting member.

Embodiments having a connecting portion, which is comprised of at least a portion of an inner clip and an outer clip, may be even more cost-effective to manufacture while still being easy to assemble.

In another aspect of the present teachings, the strut may comprise a second connection portion for connection to the second frame. The first and second connection portions may be constructed the same, e.g., in a mirrored fashion. Further, the first and second connection portions may be comprised of the inner clip and respective outer clips, as discussed above.

Embodiments having the first and second connection portions, which are each comprised of at least a portion of the inner clip and an outer clip that are constructed in a mirrored manner, have the advantage of being versatile and usable in various applications and are simple to assemble. In particular, such designs have only a single orientation that is suitable for connection to each other, such that no error in assembly can result.

In certain embodiments of the present teachings, the press-fit of the connection portion in a corresponding engaging or recess structure defined on the frame may be sufficiently secure that no adhesive is required, thereby simplifying the production of composite profiles that incorporate such struts and reducing manufacturing costs.

As used herein, the terms “strut” and “insulating strip” generally refer to the same structure, although slight differences in scope or meaning may be present. For example, a strut may not necessarily provide an insulating or thermal break function, whereas an insulating strip is intended to be formed from a thermally-insulating material.

Further objects, advantages and features of the present invention will become apparent to the skilled person upon reading the following description and appended claims in view of the drawings.

### BRIEF DESCRIPTION OF THE DRAWINGS

FIG. 1 shows a first representative strut in a detached state.

FIG. 2 shows the first representative strut in a connected state.

FIG. 3 shows the first representative strut connecting two frames.

FIG. 4 shows a modified outer clip of a second representative strut.

FIG. 5 shows the second representative strut in a connected state.

FIG. 6 shows the second representative strut connecting two frames.

FIG. 7 shows a representative method for manufacturing outer clips according to the present teachings.

### DETAILED DESCRIPTION OF THE INVENTION

Each of the additional features and teachings disclosed below may be utilized separately or in conjunction with other features and teachings to provide improved struts, insulating strips and/or composite profiles including such struts or insulating strips, as well as methods for designing, constructing and using the same. Representative examples of the present invention, which examples utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the invention. Therefore, combinations of features and steps disclosed in the following detail description may not be necessary to practice the invention in the broadest sense, and are instead taught merely to particularly describe representative examples of the present teachings.

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter.

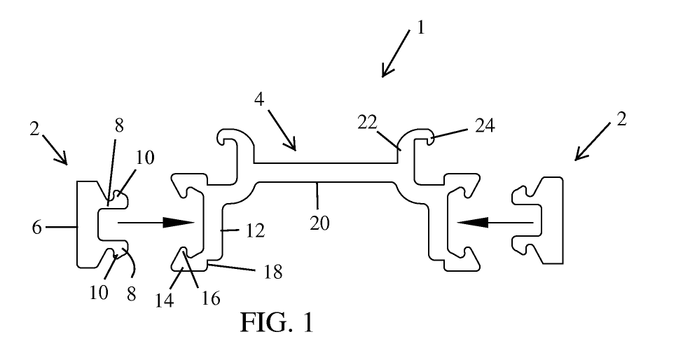

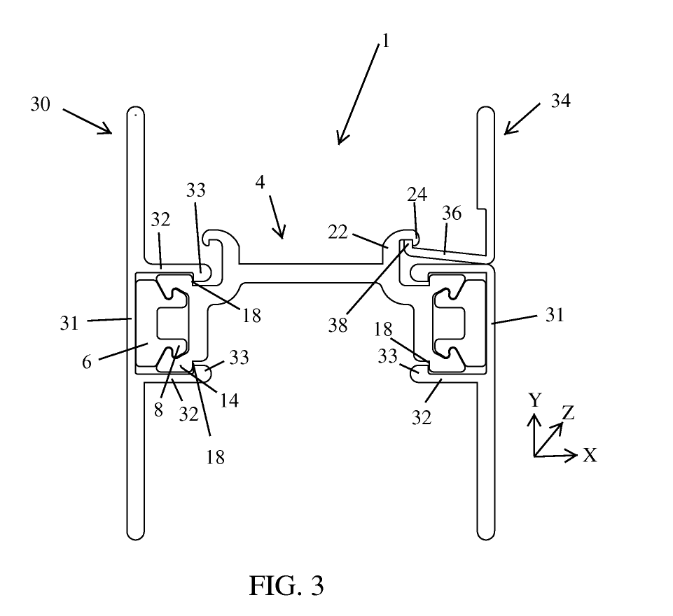

Referring to FIGS. 1-3, a first representative strut 1 for connecting to a frame or profile will be described. The first representative strut 1 generally comprises first and second outer clips 2 and an inner clip 4. All parts of the struts according to the present teachings are preferably made from a thermally-insulating material, such as a plastic material, as will be further described below, in order to provide a thermal break between two frames 30 in the connected state shown in FIG. 3. However, the material of the one or more components of the strut is not required to have thermal-insulating properties in some embodiments of the present teachings.

Each outer clip 2 preferably includes a base 6 extending in the lateral or Y direction and at least one projection 8 extending substantially perpendicularly to the base 6 in the longitudinal or X direction. For the sake of clarity, it is noted that the present description will refer to the horizontal direction in the plane of the drawings as the longitudinal or X direction of the strut 1, as well as for its components. The vertical direction in the plane of the drawings will be called the lateral or Y direction and the direction perpendicular to the X-Y plane of the drawings will be called the depth or Z direction. Thus, it should be understood that the base 6 and at least one projection 8 of the outer clip 2 are also elongated or extend in the depth or Z direction.

In the embodiment of FIGS. 1-3, two projections 8 extend substantially in parallel from the base 6 and the projections 8 define a recess between them. However, the recess is optional, as long as the outer clip 2 is at least slightly compressible in the longitudinal or X direction and imparts a restoring force in the longitudinal or X direction after being compressed.

The projection(s) 8 preferably include(s) at least one connecting mechanism 10 for connecting to or engaging with the inner clip 4. In the present exemplary embodiment, a single barbed or toothed connection 10 is shown, which has a beveled leading edge and a substantially level or flat rearward edge for engaging a complementary barb or tooth defined on the inner clip 4. The projection(s) 8 in this exemplary embodiment may also be termed a barbed or toothed flange.

Of course, the present teachings are not limited to a single barbed or toothed connection 10. Any connection configuration that provides a suitable connection of the outer clip 2 to the inner clip 4, whether it is a permanent or detachable connection, may be utilized with the present teachings. As non-limiting alternative examples, a multi-barbed/toothed flange, an arrowhead shape (i.e. barbs or teeth on opposite sides of the projection 8 in the lateral or Y direction) and/or a plunger (annular or circumferential barb or tooth) connection may be utilized with the present teachings. Other snap-fit configurations would also be acceptable, such as a peg and hole.

Furthermore, although the two outer clips 2 preferably have an identical cross-section in the X-Y plane, it is of course possible that the two outer clips 2 have different configurations and/or connecting mechanisms. For example, one outer clip 2 may have a single barbed flange and the other outer clip 2 may have, e.g., a multi-barbed/toothed flange, an arrowhead shape or a plunger/receiver connection. Thus, the present teachings are not particularly limited with respect to the types of connections that are possible between the outer clip 2 and the inner clip 4.

The inner clip 4 preferably includes at least one base 12 extending in the lateral or Y direction and at least one projection 14 extending substantially perpendicularly to the base 12 in the longitudinal or X direction. The base(s) 12 and the projection(s) 14 also extend in the depth or Z direction. The inner clip 4 of FIGS. 1-3 has two projections 14 extending from each of two bases 12.

The projection(s) 14 of the inner clip 4 also preferably include(s) a connecting mechanism 16 for connecting to or engaging with the outer clip 2, in particular the connecting mechanism 10 of the outer clip 2. A barbed or toothed connection 16 is again shown in the present embodiment, which has a beveled leading edge and a substantially level or flat edge for engaging the complementary barb or tooth 10 defined on the outer clip 2. The projection(s) 14 in this exemplary embodiment may also be termed a barbed or toothed flange.

As will be understood, the connection mechanism 16 of the inner clip 4 may have any of the configurations mentioned above for the connection mechanism 10 of the outer clip 2. It is simply preferred that the connection mechanisms 10, 16 are complementary.

The inner clip 4 also includes at least one shoulder 18 configured to be engaged by an engaging portion 33 of a frame flange 32, as will be further discussed below. In the present exemplary embodiment, two shoulders 18 are defined in, on or adjacent the opposite lateral ends of the base 12.

The inner clip 4 further includes at least one bridge 20 connecting the two outwardly-disposed bases 12. The at least one bridge 20 may extend from a lateral end of the base 12 or a central portion thereof. As will be discussed further below, more than one bridge 20 may be provided and the bridge 20 may have a variety of configurations in accordance with the present teachings.

In addition, at least one ear 22 extends from the bridge 20 in the lateral or Y direction and includes an engaging portion 24 on a tip thereof. The engaging portion 24 may be embodied, e.g., as a hook, as will be further discussed below. In the present embodiment, two ears 22 extend from opposite longitudinal ends of the bridge 20.

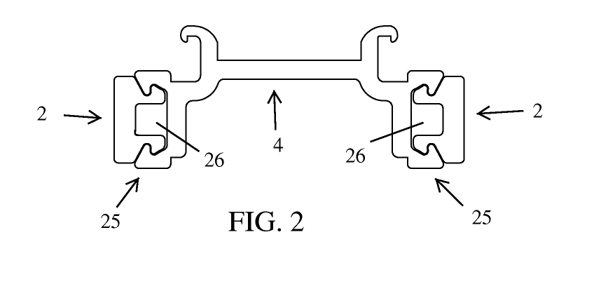

FIG. 2 shows the inner clip 4 detachably engaged with the two outer clips 2. More specifically, the respective connecting mechanisms 10, 16 are detachably engaged, thereby defining a connection portion 25 having a hollow interior 26. As indicated above, the hollow interior 26 is optional, as long as the connection portion 25 is at least slightly compressible in the longitudinal or X direction of the strut 1.

FIG. 3 shows the first representative strut 1 supporting and connecting two frames 30, which may preferably be metal frames, more preferably aluminum frames. However, rigid plastic or wood frames are also contemplated by the present teachings. PVC is a suitable plastic material for forming the frames 30. Stainless steel is also a suitable material for the frames 30. Naturally, the frames 30 also may be made of a composite material and the present teachings are not particularly limited in this regard.

The frames 30 each have a base 31 extending in the lateral or Y direction and at least one perpendicularly extending flange 32 defining the engaging portion 33 at a longitudinal terminal end thereof. The engaging portion 33 may be embodied, e.g., as a stop, flange, hook, etc., and preferably extends perpendicularly or substantially perpendicularly to the flange 32. The base 31, flange(s) 32 and engaging portion(s) 33 also extend in the depth or Z direction. In the connected state shown in FIG. 3, the engaging portion 33 contacts the shoulder 18 of the inner clip 4 when the connection portion 25 is press-fit or squeezed between the base 31 and the engaging portion 33 of the flange 32.

The material and/or the design of at least the connection portions 25 of the outer and inner clips 2, 4 is preferably resiliently elastic and thus permits at least a limited amount of compression in the longitudinal or X direction of FIGS. 1-3, wherein after compression, a restoring or biasing force then acts in the longitudinal or X direction in the direction opposite to the compression direction. Therefore, the connection portions 25 of the outer and inner clips 2, 4 will be slightly compressed between the base 31 and the engaging portion 33, thereby securely retaining the strut 1 on the frame 30. The material itself may be resiliently elastic and/or the connecting mechanisms 10, 16 may be designed to slide or move relative to each other when the connection portion 25 is press-fit between the base 31 and the engaging portion 33, whereby the connection portion 25 is compressed in the longitudinal or X direction, and then to slide or move back to a restored position thereafter, whereby the length of the connection portion 25 in the longitudinal or X direction is extended again, such that the longitudinal ends of the connection portion 25 are firmly pressed against the base 31 and engaging portion 33, respectively. In the latter case, the material of the connection portion 25 may exhibit little or no compressability in the longitudinal or X direction.

In the exemplary embodiment of FIGS. 1-3, each frame 30 has two flanges 32, which define a well or recessed structure between them. Further, the inner clip 4 has two shoulders 18 on each connection portion 25 that respectively contact or engage the two engaging portions 33. Thus, the connection portion 25 of the outer and inner clips 2, 4 are securely press-fit or compression-fit within the well or engaging structure 31-33 defined on the frame 30.

To facilitate the insertion of the connection portion 25 into the space between the flanges 32 for the first representative embodiment shown in FIGS. 1-3, it is preferable that the length of the base 6 of the outer clip 2 in the lateral or Y direction is the same or slightly less than the distance between the engaging portions 33 in the lateral or Y direction.

Further, it is preferable that the projections 8, 14 of the outer and inner clips 2, 4, respectively, are resiliently elastic also in the lateral or Y direction. In this case, the projections 8, 14 can be squeezed or compressed slightly towards each other when the connection portion 25 is pressed into the well or engaging structure 31-33. The projections 8, 14 then spread away from each other again in the lateral or Y direction due to an inherent restoring force after the base 6 of the outer clip 2 contacts the base 31 of the frame 30 and the engaging portion(s) 33 of the flange 32 contact(s) the shoulder(s) 18 of the inner clip 4. Outer lateral sides of the projections 14 are preferably flat and contact the sides of the flanges 32 in a flush manner or a substantially flush manner. Again, the lateral compression may be due to the material and/or the design of the connection portion 25.

If the projections 8, 14 are designed so as to be resiliently elastic in the lateral or Y direction, there is no need to perform a crimping, knurling or rolling-in process in order to engage the strut 1 in the well structure 31-33 defined on the frame 30. However, it is, of course, within the scope of the present teachings to form the flanges 32 of a plastically deformable material and then to utilize a crimping, knurling or rolling-in operation in order to plastically deform the flanges 32 around the connection portion 25 of the strut 1.

Naturally, the flanges 32 may preferably be at least slightly elastically deformable in the lateral or Y direction, so that the flanges 32 spread slightly outwardly when the connection portion 25 is being inserted therebetween. In this case, the length of the base 6 in the lateral or Y direction optionally may be slightly greater than the normal distance between the flanges 32 in the lateral or Y direction. The flanges 32 then elastically return to their perpendicular positions relative to the base 31 after the connection portion 25 has been fully press-fit into the well or engaging structure 31-33.

In the exemplary embodiment, the flanges 32 are formed by folding over or doubling back a sheet material forming the frame 30 and then bending one layer of the sheet material at least substantially perpendicular to the base 31. Naturally, the flanges 32 may also be integrally formed with the base 31 using a molding process or may be formed separately and then affixed to the base 31, e.g., by welding.

Still referring to FIG. 3, a frame 34 for a glass stop also may be optionally provided. This frame 34 also may include a perpendicularly-extending flange 36 having an engaging lip 38. In the engaged state, the hook 24 of the ear 22 engages the engaging lip 38, thereby also securely retaining the frame 34 on the strut 1.

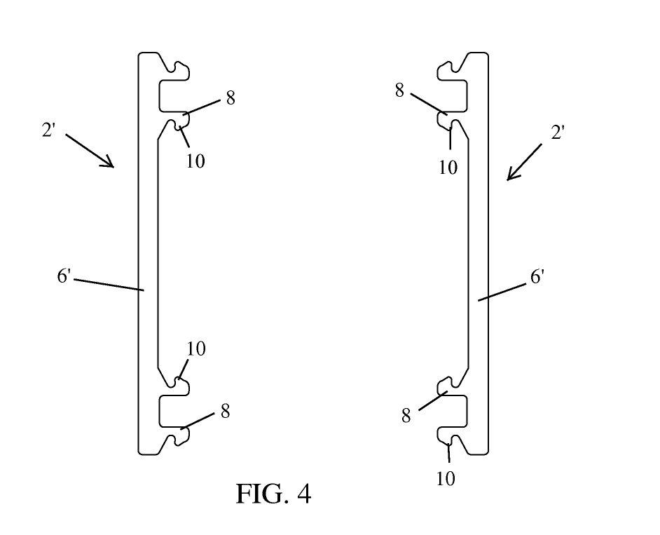

Referring to FIGS. 4-6, a second representative strut 1 will now be described. FIG. 4 shows an outer clip 2′ having a base 6′ that is elongated in the lateral or Y direction as compared to the base 6 shown in FIGS. 1-3. Four projections 8 extend substantially perpendicularly to the base 6′. Similar to the first representative embodiment, each projection 8 preferably includes a connecting mechanism 10 for connecting to or engaging with the inner clip 4. Again, the connecting mechanism 10 is a single barbed or toothed structure in this exemplary embodiment, but other connecting configurations are also possible like the first representative embodiment, as will be further discussed below.

The inner clip 4 of the first representative embodiment may be utilized in the second representative embodiment without modification. However, alternate designs for the inner clip 4 are also understood as being within the scope of the present teachings.

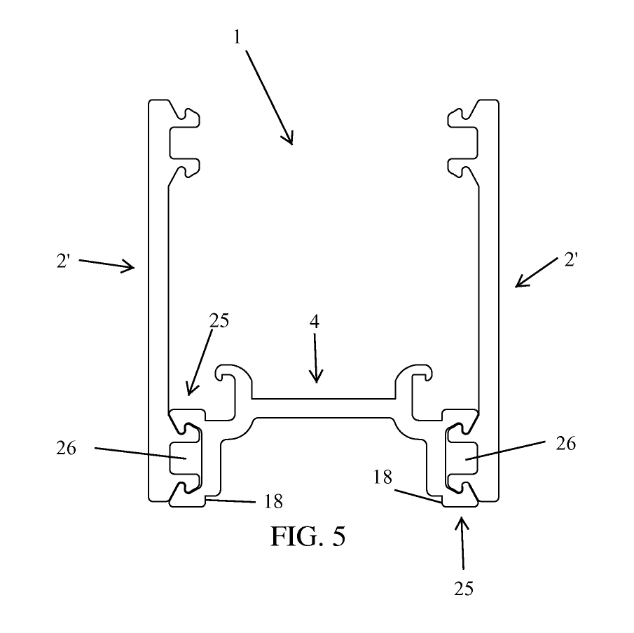

FIG. 5 shows a strut 1 having outer clips 2′ connected to the two respective terminal longitudinal ends of the inner clip 4. The connection is made in the same manner as the first representative embodiment, or the suggested modifications thereof, and therefore need not be further explained here.

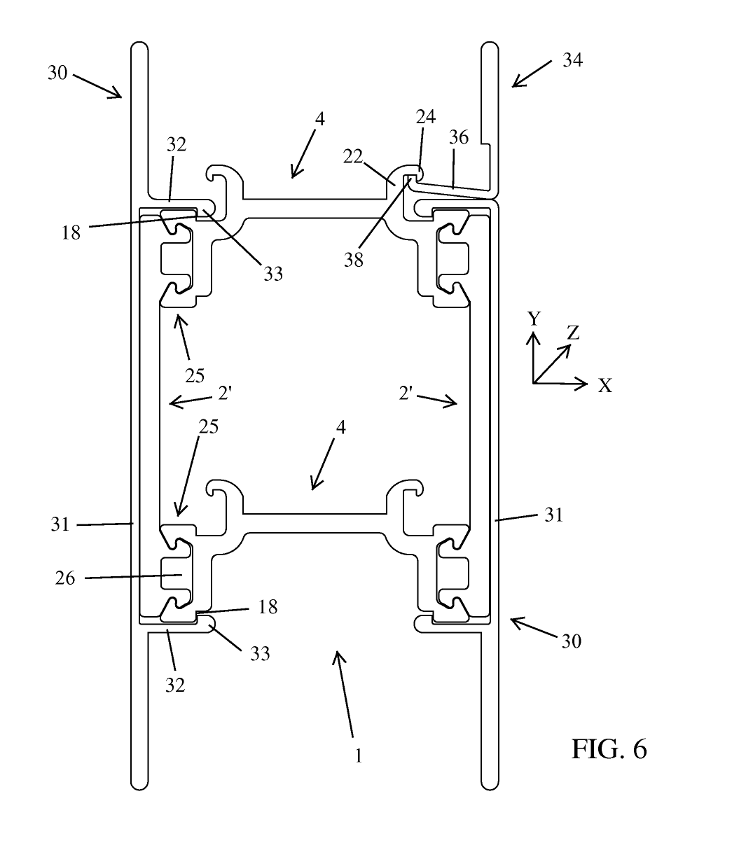

FIG. 6 shows the strut 1 of FIG. 5 connecting two frames 30. In this embodiment, the flanges 32 are spaced farther apart in the lateral or Y direction of FIG. 6 than in the first representative embodiment shown in FIG. 3, but otherwise the flanges 32 and engaging portions 33 configured to engage respective shoulders 18 of the two inner clips 4 may be formed in the same manner.

In this exemplary embodiment, the respective engaging portions 33 of the flanges 32 engage the outermost shoulders 18 of the two inner clips 4. The innermost shoulders 18 (i.e. the shoulders 18 closest to each other in the lateral or Y direction) are not utilized in such an embodiment and thus may be omitted, if desired.

Thus, the second representative embodiment also provides a secure connection between the strut 1 and the frames 30, in this case with a longer contact between the base 6′ of the outer clips 2′ and the base 31 of the frame 30.

In both the first and second representative embodiments, the outer and inner clips 2, 2′, 4 can be manufactured using standard extrusion molding techniques, although other manufacturing techniques may be utilized, such as injection molding or even machining.

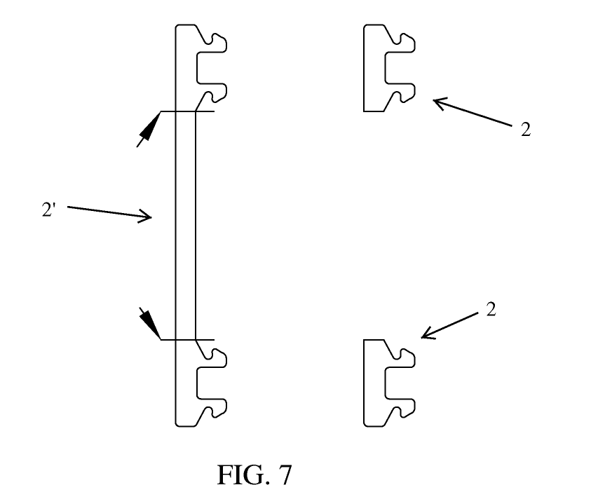

In preferred embodiments, the outer clip 2′ with two sets of projections 8 is extrusion molded as shown in FIG. 7. This outer clip 2′ can be utilized without modification in the embodiment shown in FIGS. 4-6. On the other hand, in case the present teachings will be utilized for the strut 1 according to the embodiment of FIGS. 1-3, the outer clip 2′ can be cut at the two arrows to yield two outer clips 2. Thus, this manufacturing method enables the use of a single extrusion molding die to manufacture both of the representative embodiments. Naturally, it is also possible to extrusion mold the outer clip 2 shown in FIGS. 1-3 so that it can be directly used without modification or post-production processing.

Plastic having a Young's modulus value of greater than 2000 N/mm² is advantageously utilized as the material for the strut 1. Suitable plastics are polyvinylchloride, polyamide, polyester, polyethylene terephthalate, polypropylene, polypropylene terephthalate, polybutylene terephthalate, acrylonitrile, styrene acrylate, phenolic resins and combinations or mixtures thereof, each of which may also preferably contain a reinforcing material, such as glass fiber or carbon fiber. Naturally, the plastic material(s) may also contain commonly used fillers, additives, dyes, UV-protection agents, etc., depending upon the particular application of the present teachings.

In a preferred embodiment, PA66 with 25% glass fiber content is utilized for the outer clips 2, 2′ and/or the inner clip 4. It is noted that the outer clip 2, 2′ may be formed from a material different from the inner clip 4. However, it is noted that the present strut 1 also may be utilized in applications that do not require a thermal break or insulation, such that other non-insulating materials also may be utilized to construct the strut 1.

The various portions of the strut 1 preferably have a thickness in the range of 1 mm to 50 mm, more preferably 1 mm to 10 mm, even more preferably 1 mm to 2 mm. The strut 1 preferably has a length (i.e. in the longitudinal or X direction) in the range of 10-100 mm, more preferably 15-40 mm. The strut 1 preferably has a depth (i.e. in the depth or Z direction) from 10 mm to several meters. For example, a plurality of discrete struts 1 having a relatively short depth may connect the frames 30 in the depth or Z direction or a single, relatively long strut 1 may connect the frames 30 in the depth or Z direction.

In addition to the modifications mentioned above, the present teachings may be further modified in various ways without departing from the scope or spirit of the present invention.

For example, the connecting mechanisms 10, 16 may optionally be secured using an adhesive, in which case it may not be necessary to provide mutually-engaging structures, such as barbs, arrowheads, plunger/receiver structures, snap-fit connections, etc.

Further, the base 6, 6′ of the outer clip 2, 2′ may optionally be permanently affixed to the base 31 of the frame 30, e.g., using an adhesive agent. However, the press-fit connection can be designed in such a manner that an adhesive agent is not necessary to securely connect or attach the strut 1 to the frame 30.

The outer clip 2, 2′ preferably has a substantially U-shaped cross-section in the X-Y plane, although other configurations are possible. In certain embodiments, it is preferred that the base 6, 6′ of the outer clip 2, 2′ has a surface that corresponds to the adjacent inward-facing surface of the base 31 of the frame 30, so that a relatively flush abutment of the outer clip 2, 2′ on the base 31 of the frame 30 is possible.

However, the base 6, 6′ of the outer clip 2, 2′ may also have, e.g., a ribbed, curved or angular surface. In principle, it is preferred that the frame-facing surface of the base 6, 6′ has a shape that enables the connection portion 25 to be securely press-fit or compression-fit in the well structure 31-33 of the frame 30 and various modifications are thus possible.

In addition, although the above-described preferred embodiments utilize an outer clip 2, 2′ detachably engaged with an inner clip 4, in principle, the connection portion 25 of the strut 1 can be formed as one integral piece. In such embodiments, it is preferred that the connection portion 25 is resiliently compressible in at least the longitudinal or Z direction of the strut 1, so that it can be press-fit between the base 31 and engaging portion 33 of the frame 30. Optionally, it is preferred that the connection portion 25 is also resiliently compressible in the lateral or Y direction of the strut 1, so that it can be squeezed between the flanges 32 of the frame 30.

The connection portion 25 preferably includes a hollow interior, but it may be filled, partially or completely, with any kind of at least slightly compressible interior material. It is merely preferred that the connection portion 25 is capable of providing a restoring force in the longitudinal or X direction of the strut 1 after compression, so that the connection portion 25 is securely engaged with the well or engaging structure 31-33 of the frame 30 by a press-fit or compression-fit.

In one embodiment, the strut 1 is an elongated structure that extends continuously in the Z-direction perpendicular to the sheet of the drawings. In such an embodiment, the bases 6, 6′, 12 and/or the bridge 20 may be formed of a solid material. In the alternative, the base 6, the base 6′, the base 12 and/or the bridge 20 may have through-holes defined therein, which through-holes reduce material requirements and the overall weight of the strut 1. Such through-holes also may be formed so that the base 6, 6′, the base 12 and/or the bridge 20 has a substantially ladder-shape. Such ladder-shaped struts also are useful for alleviating problems associated with the ‘hi-metal’ effect, which may cause a warping or twisting of the connected frame structure, e.g., when an outside-facing metal frame is exposed to cold temperatures and the inside-facing metal frame is exposed to much warmer temperatures. This temperature difference causes the two frames to contract and expand by different amounts.

Representative ladder-shaped struts or insulating strips are disclosed in U.S. Patent Publication No. 2010/0115850-A1, the contents of which are incorporated herein by reference.

More particularly, the base 6, 6′, the base 12 and/or the bridge 20 may have through-holes as shown in FIGS. 1, 2, 4 and 8 of U.S. Patent Publication No. 2010/0115850-A1, which are particularly incorporated herein by reference, together with the text describing these embodiments.

Furthermore, the space between the frames 30 may be hollow or may be filled, completely or partially, with a material, e.g., a foam insulating material, such as a low-density polyurethane having a density of, e.g., 0.01 to 0.3 kg/l. In addition or in the alternative, the space between the frames 30 may be sealed with an inert gas, such as nitrogen or argon, injected therein.

In addition, the bridge 20 is not required to be straight or linear and may have other shapes, e.g., curved or angled, in the longitudinal or X direction. In addition, more than one bridge 20 may extend between the respective bases 12, e.g., in parallel. The space between the bridges 20 may be hollow or filled, either partially or completely, e.g., with an insulating material, such as an insulating foam, as mentioned above. If two or more bridges 20 connect the respective bases 12, connecting pieces may extend between the respective bridges 20 in the lateral or Y direction to impart additional mechanical strength and stability to the inner clip 4. The construction of the bridge 20 is thus not particularly limited according to the present teachings.

Further, although the preferred embodiments provide struts 1 made of a single plastic material, it is also possible to embed or attach a reinforcement layer to impart additional mechanical strength or rigidity to the strut 1. For example, a metal strip, bar or rod may be disposed in or on the base 6, 6′, the base 12 and/or the bridge 20. The metal strip may comprise, e.g., steel, aluminum, tin or alloys thereof. The outer clip 2, 2′ and/or the inner clip 4 also may be formed of two or more plastic materials that are adhered or otherwise affixed together after the production thereof.

Additional teachings relevant to, and advantageously combinable with the present teachings, are found in, e.g., commonly-owned U.S. Pat. Nos. 6,035,596, 6,339,909, 6,389,779, 6,582,643, 6,989,188 and 7,104,019, as well as U.S. Patent Publication Numbers 2005-0115193, 2005-0183351, 2007-0022700, 2009-0313941, 2010-0018139 and 2010-0018140, the contents of which are hereby incorporated by reference as if fully set forth herein.

Additional embodiments of the present teachings disclosed herein include, but are not limited to:

1. A strut configured to connect first and second frames comprising:

at least one bridge extending in a longitudinal direction and being configured to provide a defined spacing between the two frames in the longitudinal direction, and

at least a first connection portion disposed on, at or near a terminal longitudinal end of the bridge, the first connection portion being resiliently elastically deformable at least in the longitudinal direction of the strut and being configured to be press-fit between a base of the first frame and an engaging portion disposed on a flange that extends substantially perpendicular from the frame base.

2. The strut of embodiment 1, wherein the first connection portion is also resiliently elastically deformable in a lateral direction of the strut, which is perpendicular to the longitudinal direction.

3. The strut of embodiment 1 or 2, wherein at least one shoulder is defined on the first connection portion and is configured to engage the engaging portion disposed on the frame flange when the first connection portion is press-fit between the frame base and the frame engaging portion.

4. The strut of any one of embodiments 1 to 3, wherein the at least one bridge is a part of an inner clip and the first connection portion comprises:

a base of the inner clip connected, directly or indirectly, to the at least one bridge, wherein at least one inner clip projection extends from the inner clip base, the projection having a first connecting member, and

an outer clip comprising a base configured to abut against a surface of the first frame and at least one outer clip projection extending from the outer clip base, the at least one outer clip projection having a second connecting member that is complementary to the first connecting member,

wherein the first connecting member is engaged with the second connecting member to define the longitudinally-compressible connection portion.

5. The strut of embodiment 4, wherein the first connecting member and the second connecting member each comprise a barb or tooth.

6. The strut of embodiment 4 or 5, wherein the first and second connecting members are detachably engaged.

7. The strut of any one of embodiments 4 to 6, wherein the at least one inner clip projection extends substantially perpendicularly from the inner clip base and substantially in parallel with the bridge and the at least one outer clip projection extends substantially perpendicularly from the outer clip base.

8. The strut of any one of embodiments 4 to 7, wherein the inner clip comprises first and second projections extending from the inner clip base, the inner clip projections each having a first connecting member, and the outer clip comprises first and second projections extending from the outer clip base, the outer clip projections each having a second connecting member.

9. The strut of embodiment 8, wherein the first and second inner clip projections extend at least substantially in parallel to each other and the first and second outer clip projections extend at least substantially in parallel to each other.

10. The strut of any one of embodiments 1 to 9, wherein the strut is comprised, at least in part, of a thermal-insulating polymer.

11. The strut of any one of embodiments 1 to 10, further comprising at least a first ear having an engaging portion extending from the at least one bridge, the ear engaging portion being configured to engage a lip defined on a third frame.

12. The strut of any one of embodiments 1 to 11, further comprising a second connection portion disposed on a terminal longitudinal end of the bridge that is opposite of the first connection portion, the second connection portion being resiliently elastically deformable at least in the longitudinal direction of the strut and being configured to be press-fit between a base of the second frame and an engaging portion disposed on a flange that extends substantially perpendicular from the frame base of the second frame.

13. The strut of embodiment 12, wherein the second connection portion is also resiliently elastically deformable in the lateral direction of the strut.

14. The strut of embodiment 12 or 13, wherein at least one shoulder is defined on the second connection portion and is configured to engage the engaging portion disposed on the frame flange of the second frame.

15. The strut of any one of embodiments 12 to 14, wherein the at least one bridge is a part of an inner clip and the second connection portion comprises:

a second base of the inner clip connected, directly or indirectly, to the bridge, wherein at least one inner clip projection extends from the second inner clip base, the projection having a third connecting member, and

a second outer clip comprising a base configured to abut against a surface of the second frame and at least one outer clip projection extending from the second outer clip base, the at least one outer clip projection having a fourth connecting member that is complementary to the third connecting member,

wherein the third connecting member is engaged with the fourth connecting member to define the longitudinally-compressible connection portion.

16. The strut of embodiment 15, wherein the third connecting member and the fourth connecting member each comprise a barb or tooth.

17. The strut of embodiment 15 or 16, wherein the third and fourth connecting members are detachably engaged.

18. The strut of any one of embodiments 15 to 17, wherein the at least one inner clip projection extends substantially perpendicularly from the second inner clip base and substantially in parallel with the bridge and the at least one outer clip projection of the second outer clip extends substantially perpendicularly from the second outer clip base.

19. The strut of any one of embodiments 15 to 18, wherein first and second projections extend from the second inner clip base, the inner clip projections each having a third connecting member, and the second outer clip comprises first and second projections extending from the second outer clip base, the outer clip projections each having a fourth connecting member.

20. The strut of embodiment 19, wherein the first and second inner clip projections extend at least substantially in parallel to each other and the first and second outer clip projections extend at least substantially in parallel to each other.

21. A composite profile comprising:

a first frame and a second frame, each frame comprising a base and at least a first flange extending substantially perpendicular to the base, wherein an engaging portion is defined on an end of the flange opposite of the base,

a strut according to any one of embodiments 1 to 20, wherein the first connection portion is press-fit in the longitudinal direction between the base and the engaging portion of the first frame.

22. The composite profile of embodiment 21, wherein at least one of the first and second frames is a metal frame, preferably an aluminum frame.

23. The composite profile of embodiment 21 or 22, wherein the second connecting portion of the strut according to any one of embodiments 12-19 is press-fit in the longitudinal direction between the base and the engaging portion of the second frame.

24. The composite profile of any one of embodiments 21 to 23, wherein the first frame comprises first and second flanges extending substantially perpendicular to the first frame base, thereby defining a first recess therebetween, and the second frame comprises first and second flanges extending substantially perpendicular to the second frame base, thereby defining a second recess therebetween, and the first and second connecting portions of the strut of one of embodiments 8-11 or 19-20 are press-fit into the first and second recesses, respectively.

### REFERENCE NUMBER LIST

1 Strut
2, 2′ Outer clip
4 Inner clip
6, 6′ Base
8 Projection
10 Connecting Mechanism
12 Base
14 Projection
16 Connecting Mechanism
20 Bridge
22 Ear
24 Engaging portion
25 Connection portion
26 Hollow interior
30 Frame
31 Base
32 Flange
33 Engaging portion
34 Frame
36 Flange
38 Engaging lip

1. A strut configured to connect two frames comprising:
at least one bridge extending in a longitudinal direction and being configured to provide a defined spacing between the two frames in the longitudinal direction, and
at least a first connection portion disposed on a terminal longitudinal end of the at least one bridge, the first connection portion being resiliently elastically deformable at least in the longitudinal direction of the strut and being configured to be press-fit between a base of a frame and an engaging portion disposed on a flange that extends substantially perpendicular from the frame base.

2. The strut of claim 1, wherein the first connection portion is also resiliently elastically deformable in a lateral direction of the strut, which is perpendicular to the longitudinal direction.

3. The strut of claim 1, wherein at least one shoulder is defined on the first connection portion and is configured to engage the engaging portion disposed on the frame flange when the first connection portion is press-fit between the frame base and the frame engaging portion.

4. The strut of claim 1, wherein the strut is comprised, at least in part, of a thermal-insulating polymer.

5. The strut of claim 1, further comprising at least a first ear having an engaging portion extending from the at least one bridge, the ear engaging portion being configured to engage a lip defined on a third frame.

6. The strut of claim 1, further comprising a second connection portion disposed on a terminal longitudinal end of the at least one bridge that is opposite of the first connection portion, the second connection portion being resiliently elastically deformable at least in the longitudinal direction of the strut and being configured to be press-fit between a base of the second frame and an engaging portion disposed on a flange that extends substantially perpendicular from the frame base of the second frame.

7. The strut of claim 6, wherein the second connection portion is also resiliently elastically deformable in a lateral direction of the strut, which is perpendicular to the longitudinal direction, at least one shoulder is defined on the second connection portion and is configured to engage the engaging portion disposed on the second frame flange when the second connection portion is press-fit between the second frame base and the second frame engaging portion and wherein the strut is comprised, at least in part, of a thermal-insulating polymer.

8. A strut configured to be connected a frame comprising:
an inner clip including at least one bridge extending in a longitudinal direction, a base connected, directly or indirectly, to or near one longitudinal end of the bridge and at least one inner clip projection extending from the base, the projection having a first connecting member, and
an outer clip comprising a base configured to abut against a base surface of the frame and at least one outer clip projection extending from the base, the at least one outer clip projection having a second connecting member that is complementary to the first connecting member,
wherein the first connecting member is engaged with the second connecting member and a longitudinally-compressible connection portion is defined by the first and second connecting members that is configured to be press-fit between the base surface of the frame and an engaging portion spaced from the frame base in the longitudinal direction.

9. The strut of claim 8, wherein the first connecting member and the second connecting member each comprise a barb or tooth.

10. The strut of claim 8, wherein the first and second connecting members are detachably engaged.

11. The strut of claim 8, wherein the at least one inner clip projection extends substantially perpendicularly from the inner clip base and substantially in parallel with the at least one bridge and the at least one outer clip projection extends substantially perpendicularly from the outer clip base.

12. The strut of claim 8, wherein the inner clip comprises first and second projections extending from the inner clip base, the inner clip projections each having a first connecting member, and the outer clip comprises first and second projections extending from the outer clip base, the outer clip projections each having a second connecting member.

13. The strut of claim 12, wherein the first and second inner clip projections extend at least substantially in parallel to each other and the first and second outer clip projections extend at least substantially in parallel to each other.

14. The strut of claim 8, wherein the inner clip further comprises:
a second base connected, directly or indirectly, to the at least one bridge, wherein at least one inner clip projection extends from the second inner clip base, the projection having a third connecting member, and
the strut further comprises:
a second outer clip comprising a base configured to abut against a base surface of the second frame and at least one outer clip projection extending from the second outer clip base, the at least one outer clip projection having a fourth connecting member that is complementary to the third connecting member,
wherein the third connecting member is engaged with the fourth connecting member to define a second longitudinally-compressible connection portion that is configured to be press-fit between the base surface of the second frame and an engaging portion spaced from the second frame base in the longitudinal direction.

15. The strut of claim 14, wherein the at least one inner clip projection extends substantially perpendicularly from the second inner clip base and substantially in parallel with the bridge and the at least one outer clip projection of the second outer clip extends substantially perpendicularly from the second outer clip base.

16. The strut of claim 15, wherein first and second projections extend from the second inner clip base, the inner clip projections each having a third connecting member, and the second outer clip comprises first and second projections extending from the second outer clip base, the outer clip projections each having a fourth connecting member.

17. The strut of claim 16, wherein the first and second inner clip projections extend at least substantially in parallel to each other and the first and second outer clip projections extend at least substantially in parallel to each other.

18. The strut of claim 17, wherein a shoulder portion is defined on each of the first base and the second base of the inner clip, the shoulder portions being configured to respectively engage the engaging portions of two frames.

19. An apparatus comprising:
a first frame and a second frame, each frame comprising a base and at least one flange extending substantially perpendicular to the base, wherein an engaging portion is defined on an end of each flange opposite of the respective base, and
a strut comprising at least one bridge extending in a longitudinal direction, a first connection portion disposed on a first terminal longitudinal end of the bridge and a second connection portion disposed on a second terminal longitudinal end of the bridge, the connection portions being resiliently elastically deformable at least in the longitudinal direction of the strut, wherein the first and second connection portions are press-fit in the longitudinal direction between the base and the engaging portion of the respective first and second frames.

20. The apparatus of claim 19, wherein at least one of the first and second frames is a metal frame and the strut is at least partially comprised of a thermal-insulating polymer.

21. The apparatus of claim 20, wherein the first frame comprises first and second flanges extending substantially perpendicular to the first frame base, thereby defining a first recess therebetween, and the second frame comprises first and second flanges extending substantially perpendicular to the second frame base, thereby defining a second recess therebetween, and the first and second connecting portions of the strut are press-fit into the first and second recesses, respectively.
